(19) United States
(12) Patent Application Publication
(10) Pub. No.: US 2005/0192975 A1
(43) Pub. Date: Sep. 1, 2005

(54) Resource management system for electronic devices

(75) Inventors: Frank Ernest Reiner, Harleysville, PA (US); Anthony Bowden, Sayville, NY (US); William J. Merritt, Lititz, PA (US); Joseph W. King, Audubon, PA (US)

Correspondence Address: VOLPE AND KOENIG, P.C.;DEPT. ICC, UNITED PLAZA, SUITE 1600, 30 SOUTH 17TH STREET, PHILADELPHIA, PA, 19103, US

(73) Assignee: InterDigital Technology Corporation, Wilmington (US)

(21) Appl. No.: 10/779,170

(22) Filed: Feb. 12, 2004

(51) Int. Cl. G06F 7/00

(52) U.S. Cl. 707/100

(57) ABSTRACT

A resource management system for an electronic device having at least one system resource includes a resource manager for monitoring the usage of the system resource; a remote resource; and a communication link for transmitting data between the system resource and the remote resource. The resource manager transmits data over the communication link from the system resource to said remote resource when the utilization of the system resource approaches a predetermined threshold.

### FIELD OF INVENTION

The present invention is generally related to electronic devices. More particularly, the present invention is directed to a system which manages and supplements the resources within an electronic device.

### BACKGROUND

The use of handheld, mobile and wireless devices has become ubiquitous in today's society. For example, personal Digital Assistants (PDAs) provide a high degree of functionality in a handheld unit by supporting most common business and home software applications such as word processing, database management, spreadsheet management, and e-mail, and by storing all of the information associated with such applications. As a result, PDAs have become a necessity for anyone desiring to store different types of information in a conveniently accessible and functional device.

As another example, wireless telephones have become a necessary information appliance for everyday living. Many current phones include all of the functionality of a PDA, plus additional functionality such as digital photographic capabilities and, of course, the ability to support data or voice communications.

There exist many other consumer and business electronic devices which are not typically wireless-enabled but nonetheless share some of the same functionalities as wireless devices. These non-wireless devices may include, for example, MP3 music players, compact disk players, digital voice recorders, camcorders, cameras and video cassette recorders (VCRs).

Although all of these devices have different purposes, different functionalities and different capabilities, they all have in common several basic functions, such as data storage and data processing. With respect to data storage, each device must have the ability to store, either temporarily or permanently, a certain amount of data. The type, permanency and amount of data varies greatly depending upon the device and the application. Although it is desirable to include as much memory as possible within an electronic device, such memory is typically very expensive and the cost of memory may become a large portion of the overall cost of the device. The data storage limitations are particularly acute for hand-held or portable devices. As a result, manufacturers must make a trade-off between including as much memory as is desired by users, while limiting the memory in order to limit the price of the electronic device. A patchwork system of memory cards is often employed by users in order to supplement the memory of electronic devices when the users require more extensive memory capabilities.

With respect to processing power, manufacturers must make the same trade-off decision to incorporate as much processing power as desired by most users, while limiting such capabilities in order to keep the ultimate price of the device with an affordable range for most users. For a user that exceeds the processing capabilities of a purchased hand-held device, there is typically no solution for increasing the processing capabilities other than to abandon the current hand-held device in favor of a newer, more expensive device with greater processing capabilities.

The limited nature of these capabilities severely restricts the functionality of many of these devices, thereby reducing the usefulness and enjoyment of these devices by the user. It would be desirable if hand-held and mobile devices were not encumbered with such limited capabilities.

### SUMMARY

The present invention is a management system for electronic devices which monitors the status of the finite resources in an electronic device and communicates with a resource server facility in order to supplement and enhance such resources. In a first embodiment, in the case of memory for example, the system monitors the amount of memory being utilized by the electronic device and automatically uploads information from the electronic device to the resource server facility in order to free-up memory within the electronic device. The upload is programmable by the user such that data is uploaded from the device at off-peak times or other times or conditions selected by the user. The system also identifies and keeps track of information that is uploaded to the resource server facility so that the information may be seamlessly retrieved from the resource server facility by the electronic device without knowledge from the user, or may be programmably controlled by the user such that data is transmitted during off-peak hours or at other times or conditions selected by the user. As a result, from the perspective of the user, the hand-held device has an infinite amount of memory.

The system of the present invention also includes the ability to access information stored as the resource server facility either directly at the electronic device or via other means, such as by Internet access by the user or by a designee of the user.

### BRIEF DESCRIPTION OF THE DRAWING(S)

FIG. 1 is a resource management system for electronic in accordance with the present invention.

FIG. 2 is the resource management system of FIG. 1 shown in greater detail.

FIG. 3 is a detailed block diagram of a resource client made in accordance with the present invention.

FIG. 4 is a data packet including a data block and a header.

FIG. 5 is the header of FIG. 4.

FIG. 6 is a flow diagram of a preferred method implemented at the resource client in accordance with the present invention.

FIG. 7 is a detailed block diagram of the resource unit made in accordance with the present invention.

FIG. 8 is a flow diagram of a preferred method implemented at the resource unit in accordance with the present invention.

### DETAILED DESCRIPTION OF THE PREFERRED EMBODIMENT(S)

The present invention will be described with reference to the drawing figures wherein like numerals represent like elements throughout.

When referred to hereafter, the terminology wireless transmit/receive unit (WTRU) includes but is not limited to a user equipment, mobile station, fixed or mobile subscriber unit, pager, or any other type of device capable of operating in a wireless environment.

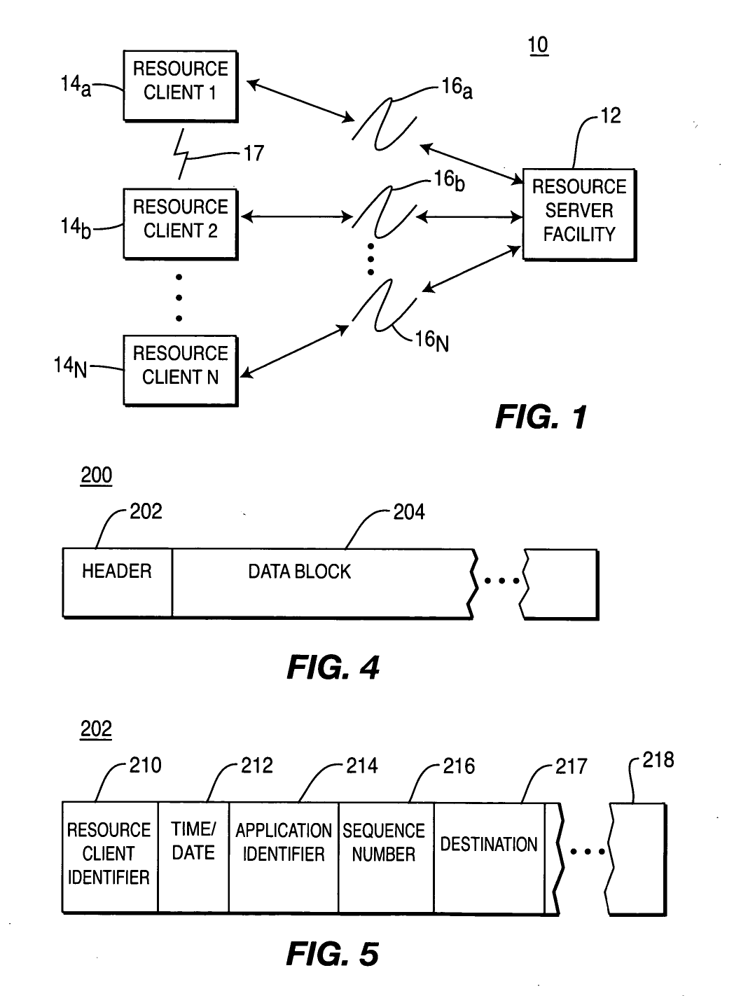

Referring to FIG. 1, a management system 10 for electronic resources in accordance with the present invention is shown. A resource server facility 12 is coupled to a plurality of resource clients 14ₐ, 14_{b} . . . 14_{N} via a plurality of communication links 16ₐ, 16_{b} . . . 16_{N}.

In the preferred embodiment of the present invention, the communication links 16ₐ-16_{N} are wireless links between wirelessly-enabled resource clients 14ₐ-14_{N} and a wirelessly-enabled resource server facility 12, and this is the embodiment of the present invention that be described hereinafter. However, those of skill in the art should realize that the communication links 16ₐ-16_{N} could comprise a conventional public-switched telephone network (PSTN), a cable television (CATV) network or a local or wide area network (LAN/WAN) as just a few examples, without departing from the spirit and scope of the present invention.

The resource clients 14ₐ-14_{N} have the ability to upload and download data over the communication links 16ₐ-16ₙ for storage and/or processing by the resource server facility 12. Although a single communication link (for example, 16ₐ) is shown as coupling a single resource client 14ₐ to the resource server facility 12, it should be understood by those of skill in the art that the communication link 16ₐ need not be implemented directly from the resource client 14ₐ to the resource server facility 12. For example, utilizing such wireless protocols as Bluetooth, the first resource client 14ₐ may communicate with the second resource client 14_{b} over a first wireless link 17, and thereafter the second resource client 14_{b} may communicate with the resource server facility 12 over another communication link 16_{b}. The number and/or types of communication links is not important, rather it is only necessary to have the ability to couple a resource client, 14ₐ-14ₙ to the resource server facility 12 either directly or indirectly by some configuration.

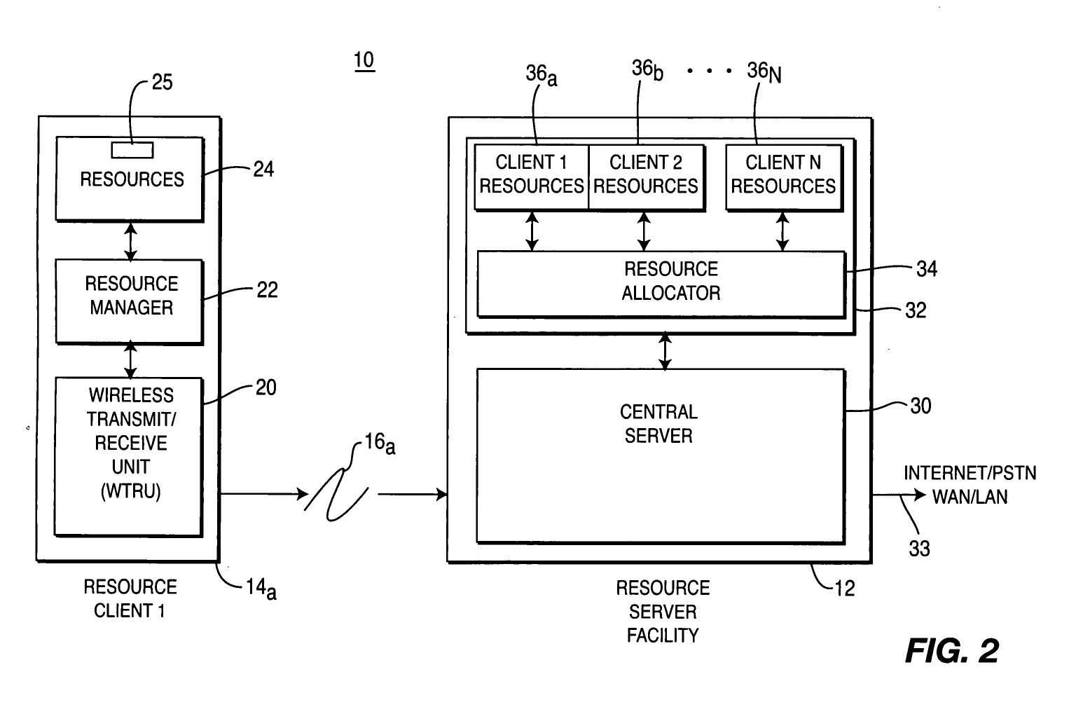

Referring to FIG. 2, the management system 10 is shown in greater detail. Although only the first resource client 14ₐ and the first communication link 16ₐ are shown for simplicity, it should be understood that other resource clients 14_{b}-14ₙ operate in a similar manner. The resource client 14ₐ includes a wireless transmit/receive unit (WTRU) 20, a resource manager 22 and a plurality of system resources 24. Since the preferred communication link 16ₐ is a wireless link, the WTRU 20 functions as the intermediary between the wireless communication link 16ₐ and the resource manger 22. The WTRU performs all the functions associated with RF transmission and reception including up/down-conversion, encryption/decryption, spreading and despreading, etc.

The system resources 24 include any of the resources which are typically utilized by the system to support an application. For example, this includes a microprocessor and a memory. The resource manager 22 monitors all the system resources 24 of the resource client 14ₐ and, as will be described in detail hereinafter, selectively manages the system resources 24 such that they can be supplemented by the resource server facility 12.

An application 25 being run on the resource client 14ₐ is shown for simplicity as being a single application, although those of skill in the art would realize that several applications would most likely run simultaneously on the resource client 14ₐ. The application 25 which will be described in detail will be the photographic camera application. However, this is just by way of example and not by way of limitation. Any of the applications described hereinbefore, or applications which have not been described hereinbefore, are intended to be illustrated by application 25.

The application 25 utilizes the memory, data processing and other resources of the resource client 14ₐ as needed. The use of those resources is constantly monitored by the resource manager 22. As will be explained in greater detail hereinafter, the resource manager 22 knows the capacity of the resources, (for example, processing speed and memory size), and as those resources approach their capacity, the resource manager 22 communicates with the resource server facility 12 in order to supplement those resources.

The resource server facility 12 includes a central server 30, and a resource unit 32, which includes a resource allocator 34 and a plurality of client resource units 36ₐ, 36_{b} . . . 36ₙ.

The central server 30 acts as an intermediary between the communication link 16ₐ and the resource unit 32. These intermediary functions include all the aforementioned RF capabilities as well as other capabilities, such as providing an outside communication link 33 to other communication entities via the internet, a PSTN, a WAN or an LAN. The central server 30 also acts as a router to route information between the communication link 16ₐ, the outside communication link 33 and the resource unit 32.

The resource unit 32 provides all of the resource management within the resource server facility 12. The resource allocator 34 tracks the amount of resources associated with each client resource 36ₐ-36ₙ and allocates additional resources as needed to a particular client, while also deallocating resources if they are no longer needed. The resource allocator 34 may also provide tracking of the amount, type and duration of resources that are utilized by each resource client for later use, such as for billing and record keeping purposes.

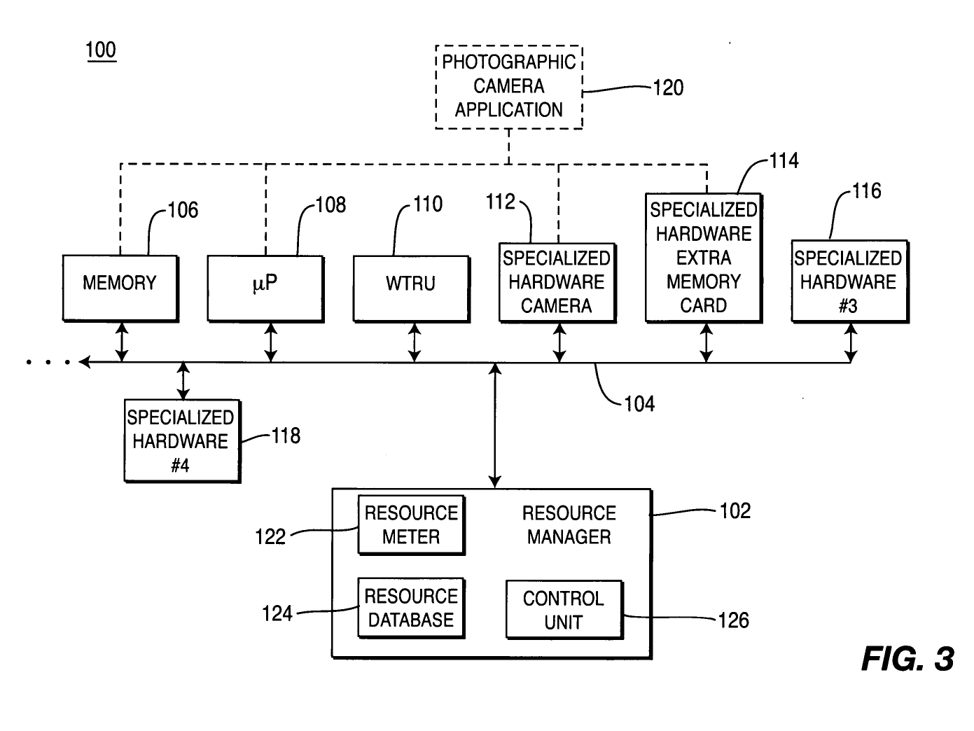

The resource client 100 will be explained in greater detail with reference to FIG. 3, which shows a photographic camera application. The resource client 100 includes a memory 106, a microprocessor 108, the WTRU 110, a first specialized hardware module comprising a camera 112, a second specialized hardware module comprising an extra memory card 114, two additional (optional) specialized hardware modules 116, 118, the resource manager 102, (which includes a resource meter 122 and a resource database 124), and a communication bus 104.

All of the components within the resource client 100 communicate over the communication bus 104. Although the communication bus 104 has been shown for simplicity as a single bus, those of skill in the art should realize that separate control and/or data buses may be provided. Additionally, some of the specialized hardware modules 112-118 may communicate directly with one or more of the other modules 102, 106, 108, 110 depending upon the system design. The specific configuration of the communication bus 104 is not central to the present invention. It is preferable that the resource manager 102 be able to communicate directly or indirectly with all of the resources within the resource client 100 in order to effectively monitor and manage those resources.

The memory 106 is the main storage unit within the resource client 100. However, it should be noted that at least several of the other modules within the resource client 100 may include at least a small amount of additional memory, (such as the camera 112). These additional memories may also be managed by the resource manager 102.

The microprocessor 108 is the primary data processing capability of the resource client 100. Again, it is likely that one or more of the other components within the resource client 100 will include additional data processing capabilities.

The WTRU 110, as aforementioned, provides a wireless interface between the resource client 100 and the communication link 16a.

The specialized hardware modules 112, 114, 116, 118 are modules which may be either be permanent or removable, (e.g. may be inserted or removed as desired by the user depending on the specific application.) Several currently known, and widely used, removable modules on existing PDAs include GPS-based navigation modules and digital camera modules. An example of a permanent module would be the digital camera functionality built into a wireless cellular phone. For the present example of the photographic camera application 120, two specialized hardware components as shown comprise a camera 112 and an extra memory card 114.

The photographic camera application 120 is graphically illustrated via the dashed line as utilizing the resources of the memory 106, the microprocessor 108, the camera 112, and the extra memory card 114. However, those of skill in the art would realize that this illustration is functional. The software for the photographic camera application 120 would most likely reside within the memory 106, and would utilize the microprocessor 108 to control the flow of data between the memory 106, the camera 112 and the extra memory card 114.

The resource manager 102 includes a resource meter 122, a resource database 124, and a control unit 126. The resource database 124 stores the capacity of each resource. The resource meter 122 tracks the current usage of each resource. The control unit 126 compares the current usage as tracked by the resource meter 122 with the capacity of the resources as stored in the resource database 124. If one of the resources is close to full capacity, or within a predetermined threshold, such as 80%, the control unit 126 augments the resources within the resource client 100 with additional resources available at the resource server facility 12 or at some other entity.

As will be explained in greater detail hereinafter, in one embodiment, the control unit 126 requests additional resources from the resource server facility 12, and manages all aspects of the transmission of data from the resource client 100 to the resource server facility 12 or to other entities if desired. If the request is granted, the control unit 126 reads data from one of the memories 106, 114, attaches an identifier to the data, and transmits the data to the resource server facility 12. This frees-up the memory that was used to store the data for further use by the resource client 100. Transmitting the data as described herein is intended to include e-mailing, IR beaming, uploading or any other data forwarding technology.

In an alternative embodiment of the present invention, the control unit 126 may, in addition to, or in place of, transmitting data to the resource server facility 12, may transmit the data to another entity. This is accomplished, for example, using the Bluetooth protocol to transmit the data to a wireless device within the vicinity of the resource client 100, or by e-mailing the data to one or more entities as specified by the user. The destination of the data, whether it be the resource server facility 12 or another entity, is a parameter which is configurable by the user. Once the data is, for example, e-mailed to the other entity, that portion of memory (such as memory 106, 114) that was used to store the data is available for further use by the resource client 100.

Also configurable is a parameter as to the timing of the transmitting of the data. For example, as aforementioned, data may be transmitted immediately when one of the resources is close to full capacity or within a predetermined threshold. Alternatively, data may be transmitted on a periodic basis, or during off-peak times. The timing of the transmission of the data is another parameter that is configurable by the user and controlled by the control unit 126.

Since the resource manager 102 ensures that the resources within the resource client 100 are not fully utilized, from the perspective of the photographic camera application 120, the resources appear to be unlimited.

Referring to FIG. 4, a data packet 200 is shown. The data packet 200 includes a header 202 and a data block 204. The data block 204 is the data that is read from one of the memories 106, 114 by the resource manager 102 and transmitted to the resource server facility 12 in order to free-up memory for further use by the resource client 100. The control unit 126 within the resource manager 102 generates and attaches the header 202 to the data block in order to provide an identification for the data block 204. One embodiment of the header 202 is shown in greater detail in FIG. 5.

Referring to FIG. 5, one embodiment of the header 202 in accordance with the present invention includes the resource client identifier field 210, a time/date stamp field 212, an application identifier field 214, a sequence number field 216, and a destination field 217. As shown, one or more additional fields 218 may be added as desired by the user, or less fields may be used if not required.

The resource client identifier field 210 identifies the particular resource client from which the data originated. This will permit the resource server facility 12 to properly route and store all of the information from a particular resource client 100 in the proper location.

The time/date field 212 includes a time/date stamp for when the information was transmitted and/or when the information was stored in the memory.

The application identifier field 214 includes an identification of the particular application, (for example word processing, database or photographic application), to which the particular data block 204 pertains.

The sequence number field 216 is an identifier of which position, within a plurality or sequence of data blocks, the particular data block 204 pertains. This assists the resource server facility 12 in retrieving information an orderly manner.

The destination field 217 is an optional field that may be left empty, or not included, if the data block is destined for the resource server facility 12. If the destination field 217 is included, it may comprise the e-mail address or other identifying address such as a device address, to which the data is destined. For example, if the destination field 217 includes an e-mail address, the data packet 200 will be forwarded to that e-mail address. The destination field 217 may include more than one address, including an identifier for the resource server facility 12.

It should be noted by those of skill in the art that the basic function of the header 202 is to provide some type of identification for the transmitted data so that it may be easily retrieved. Accordingly, the particular fields 210-218 shown in FIG. 5 maybe supplemented, changed or deleted as desired by the particular application without departing from the spirit and the scope of the present invention. For example, field 218 may comprise a timing field, whereby the control unit 126 holds the data packet until the time identified in the timing field 218. This permits the control unit 126 to control when a data packet 200 is to be transmitted.

Alternatively, a timing field 218 does not need to be included within the header 202. The timing of when the data packet 200 is transmitted may be controlled directly by the control unit 126 either periodically, aperiodically or during a specified time, such as an off-peak time.

As another option, a security field may be included to identify the level of security with which the data packet 200 should be treated. For example, at the destination, a data packet 200 with a low security level will be able to be accessed by all personnel, whereas a data packet 200 with a high security level will be able to be viewed by only individuals who are granted the appropriate high level of access. This function will be described in greater detail hereinafter with reference to the resource server facility 12.

Preferably, when the data packet 200 is transmitted, a copy of the header 202 is stored by the control unit 126 such that data retrieval by the user is seamless and performed upon demand.

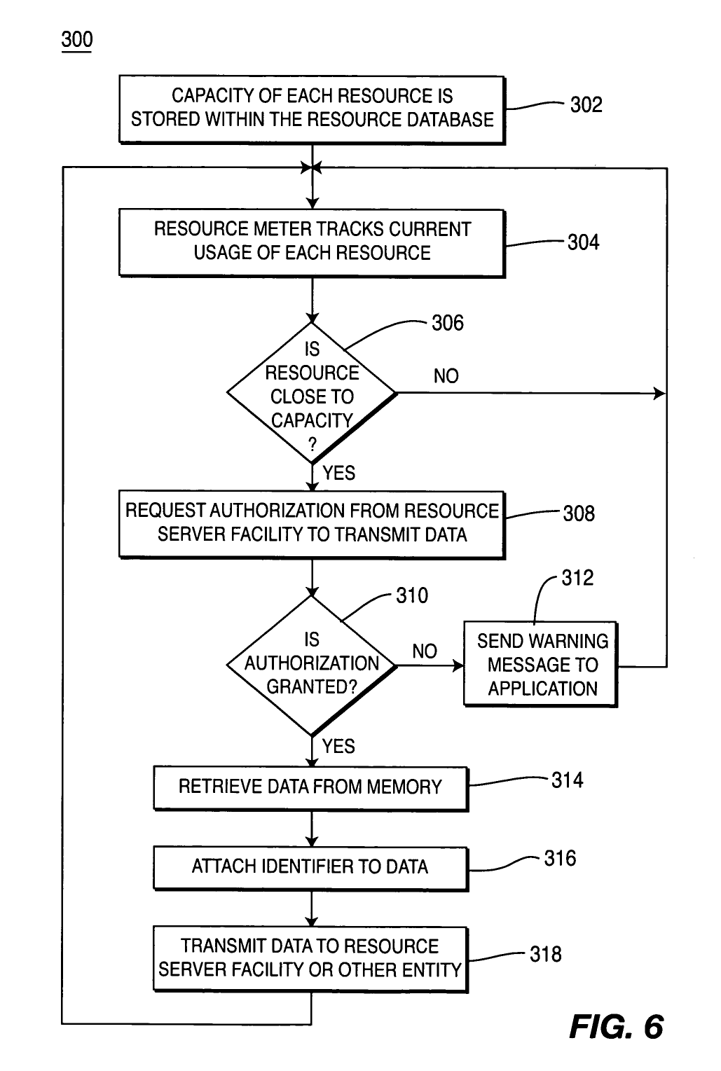

Referring to FIG. 6, the procedure 300 implemented by the resource manager 102 to augment system resources within the resource client 100 in accordance with the present invention is shown. The procedure 300 will be described as reference to the aforementioned example of a particular type of resource, (i.e. the memory). However, those with skill in the art should realize that any type of resource within the resource client 100 may be managed in a similar manner. The procedure 300 begins as a value representing the capacity of each resource within the resource client 100 is stored within the resource database 124 (step 302). The resource meter 122 tracks the current usage of each resource (step 304). A determination is made at step 306 whether each resource is close to capacity.

If a resource is not close to its capacity, the procedure 300 returns to step 304. If a resource is close to its capacity, (as determined at step 306), the control unit 126 requests authorization from the resource facility 12 to transmit data (step 308). If authorization is not granted at step 310, the control unit 126 sends a warning message to the particular application, (in this case the photographic camera application 120) noting that the particular resource, (in this example the memory), is close to capacity (step 312).

If authorization is granted at step 310, the control unit 126 retrieves data from one or more of the memories 106, 114 (step 314) attaches an identifier to the data (such as a header 202) (step 316), then transmits the data to the resource server facility or to another entity as appropriate (step 318) either immediately, or on a periodic or other-specified basis. The procedure 300 then returns to step 304 to repeat steps 304-318 as needed.

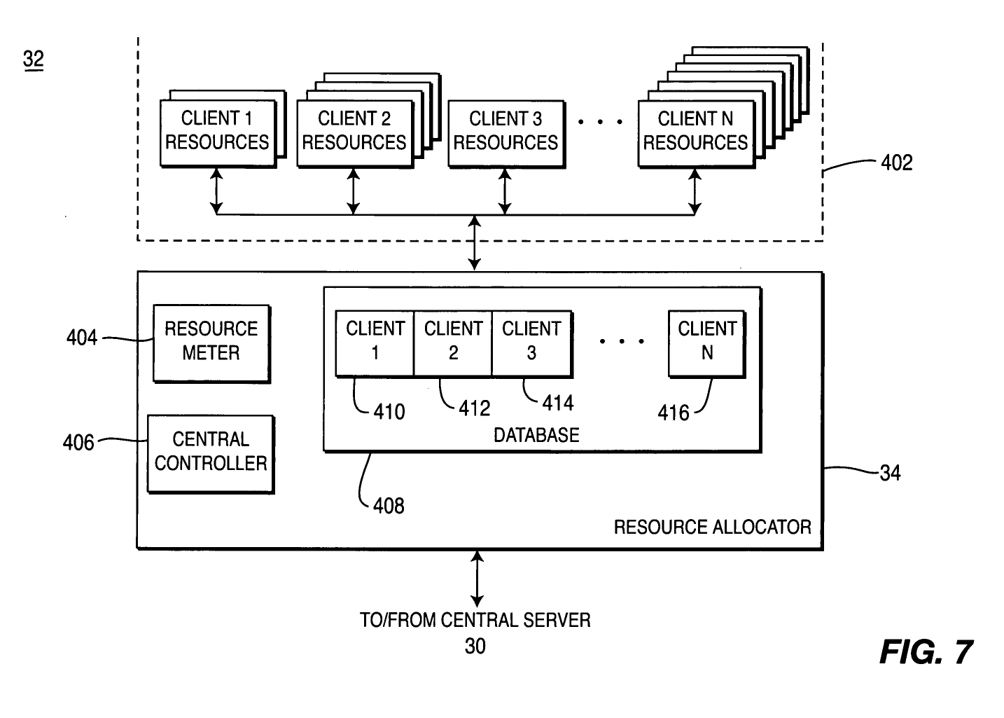

The resource unit 32 is shown in greater detail in FIG. 7. The resource unit 32 includes the resource allocator 34 and a plurality of central resources 402. In continuing with the present example, the central resources 402 will be described as additional memory. However, the present invention is intended to cover any type of additional resources that may be augmented at the resource server facility 12 or other entity.

The resource allocator 34 includes a resource meter 404, a central controller 406, and a database 408.

The resource meter 404 tracks the usage of all of the resources within the central resource 402. The database 408 includes a plurality of files 410, 412, 414, 416, one for each resource client, that tracks the type, number and duration of resources within the central resource 402 used by each resource client.

The database 408 tracks this information for later use, such as for billing each resource client depending upon the type and amount of resources that are used, as well as providing statistical data to assure that enough resources are made available for use by different resource clients.

The central controller 406 controls all of the resources within the central resource 402 and controls all information entering or exiting the resource allocator 34 to/from the central server 30. The central controller 406 may also provide a security function to ensure that each data packet 200 is accessed by only users having the proper level of authorization. For example, the central controller 406 may provide a web page function, whereby users may access and manage their resources directly through the resource server facility 12 via the internet or by other means. As a result, data packets having a low level of security may be accessible to all personnel where other data packets having a high level of security may only be accessible via personnel who have the proper level security authorization.

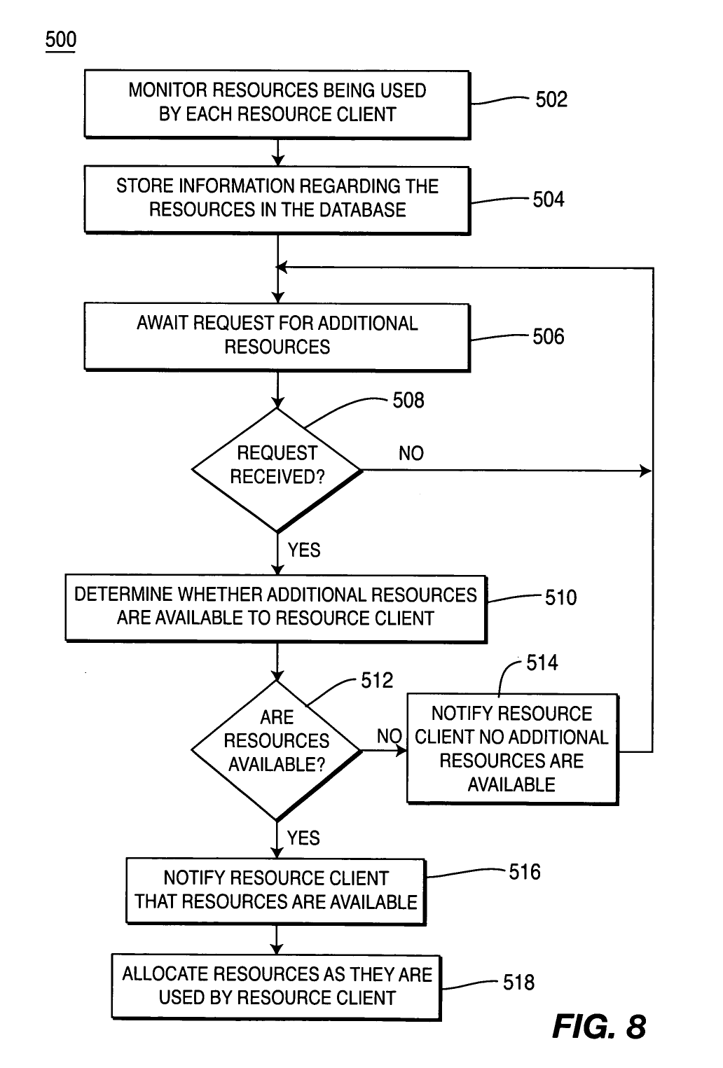

A procedure 500 utilized by the resource allocator 34 to allocate additional resources (i.e. additional memory) is shown in FIG. 8. The central controller 406 monitors the central resources 402 being used by each resource client (step 502). Information regarding the use of central resources 402 for each resource client is stored in the database 408. The central controller 406 awaits a request for additional resources (step 506). If no request is received as determined at step 508, the procedure 500 returns to step 506 to await such a request.

If the request has been received, as determined at step 508, the central controller 406 monitors the resource meter 404 and the database 408 to determine whether additional resources are available to that particular resource client (step 510). Additional resources may not be available for two basic reasons. First, the resources 402 may have been exhausted as noted by the resource meter 404, whereby no additional resources to any resource client are available. This is an unlikely event since an operator will most likely ensure that the amount of central resources exceeds the amount of resources that are required by a vast margin.

A much more likely reason that resources are unavailable is that a resource client has not paid for the amount of additional resources desired. If the additional resources are not available as determined at step 512, a notification is sent to the resource client to inform the resource client that no additional resources are available (step 514). The procedure 500 then returns to step 506.

If resources are available as determined at step 512, the central controller 406 notifies the resource client that such resources are available (step 516) and allocates the resources as they are used by the resource client (step 518).

Although the photographic application has been described in detail hereinbefore, there are many other applications which are clearly within the capabilities of the present invention. For example, real-time video recording, music recording, or audio recording can all be accommodated via the system and method of the present invention. For an audio recording example, a cellular phone may be utilized as a recording device, whereby the information is transmitted to the resource server facility when the memory within the cell phone approaches its capacity. Likewise, a camera which takes still photos or a video recorder which records live video pictures, may upload to a resource server facility when their memories approach capacity. As aforementioned, uploading may be performed upon reaching a predetermined limit of the capacity of the device, may be performed periodically or may be performed during off-peak hours.

Although the procedures 300, 500 shown and described with reference to FIGS. 6 and 8, respectively, include the use of a request for resources to be sent from the resource client 100 to the resource server facility 12, it should be noted by those of skill in the art that such a request is optional. It may be assumed by the resource client 100 that the resource server facility 12 has the capacity necessary to receive the transmitted data. Thus, the resource client 100 may transmit the data as desired without such a pre-approval.

1. A resource management system for an electronic device having at least one system resource, the system comprising:
a resource manager for monitoring the usage of said at least one system resource;
a remote resource; and
a communication link for transmitting data between said at least one system resource and said remote resource;
whereby the resource manager transmits data over said communication link from said at least one system resource to said remote resource when the utilization of said at least one system resource approaches a predetermined threshold.

2. The system of claim 1 wherein said at least one resource and said remote resource are memories.

3. The system of claim 1 wherein said remote resource comprises a resource server facility.

4. The system of claim 1 wherein said resource manager further comprises:
a resource database, for storing a value representing the capacity of said at least one resource;
a resource meter for determining the current usage of said at least one resource; and
a control unit, for comparing said value to said current usage to determine whether data within said at least one resource should be transmitted to said remote resource.

5. The system of claim 4, wherein said control unit automatically copies data from said at least one system resource and transmits the data to said remote resource when said threshold is exceeded.

6. The system of claim 1 wherein said remote resource comprises:
a plurality of central resources;
a central controller for selectively assigning central resources for use by a plurality of electronic devices;
a resource meter for tracking the current usage of said plurality of central resources;
and a database, including at least one file for each electronic device, for tracking the usage of said central resources by each electronic device.

7. The system of claim 6, wherein said usage comprises the amount of said central resources.

8. The system of claim 1 wherein said communication link is a wireless communication link.

9. The system of claim 1 wherein said resource manager transmits the data over said communication link at a predetermined time.

10. A method for management of at least one system resource in an electronic device comprising:
monitoring said at least one system resource;
determining whether the utilization of said at least one system resource has exceeded a predetermined threshold;
transmitting data from said at least one system resource to a remote resource when said threshold has been reached; and
storing data at said remote resource.
